(19) United States
(12) Patent Application Publication
(10) Pub. No.: US 2017/0208358 A1
(43) Pub. Date: Jul. 20, 2017

(54) DEVICE FOR AND METHOD OF TV STREAMING AND DOWNLOADING FOR PERSONAL PHOTOS AND VIDEOS PRESENTATION ON TV THAT SEAMLESSLY INTEGRATES WITH MOBILE APPLICATION AND CLOUD MEDIA SERVER

(71) Applicant: Atriva Media Inc., Fremont, CA (US)

(72) Inventor: Wei-Jen Li, Fremont, CA (US)

(21) Appl. No.: 15/406,956

(22) Filed: Jan. 16, 2017

Related U.S. Application Data
(60) Provisional application No. 62/280,983, filed on Jan. 20, 2016.

(51) Int. Cl. H04N 21/431; H04N 21/81; H04N 21/258; H04N 21/482

(52) U.S. Cl. CPC H04N 21/4314; H04N 21/4821; H04N 21/4316; H04N 21/81; H04N 21/25875; H04N 21/25858

(57) ABSTRACT

A method of and device for streaming and downloading media/photo on TV presented in media channels. The media managing method comprises sorting media according to one or more characteristics of each of the media, forming media channels based on the one or more characteristics associated with the media, and presenting the media in one of the media channels.

CROSS-REFERENCE TO RELATED APPLICATION(S)

This application claims priority under 35 U.S.C. §119(e) of the U.S. Provisional Patent Application Ser. No. 62/280,983, filed Jan. 20, 2016 and titled, “DEVICE FOR AND METHOD OF TV STREAMING FOR PERSONAL PHOTOS AND VIDEOS PRESENTATION ON TV THAT SEAMLESSLY INTEGRATES WITH MOBILE APP AND CLOUD MEDIA SERVER,” which is also hereby incorporated by reference in its entirety for all purposes.

### FIELD OF THE INVENTION

The present invention relates to the field of multimedia. More specifically, the present invention relates to photos and videos presentation on television.

### BACKGROUND OF THE INVENTION

FIG. 1 illustrates a typical TV program guide 100. The typical TV program guide 100 often contains channel numbers at left side 102 of the screen and the TV program information at the right side 104 of the screen. Generally, the TV programs are arranged in a format of pre-arranged time period 106. Users usually scroll up and down on the channels and left and right for searching the desired TV programs.

Further, FIG. 2 illustrates a typical media album structure 200. The typical media album is arranged according to events 202, which are generally randomly named by dates, locations, or events. The photos 204 are popped up when a specific event item is selected. Although users are able to create albums of their own, generally most of the photos are left in a default album, such as “Camera Roll.” As a result, most of the photos are left unorganized. The unorganized photos are hard to search, enjoy, and share among users.

### SUMMARY OF THE INVENTION

A method of and device for streaming and downloading media/photo from a cloud, mobile or other local storage device to be presented on TV. In an aspect, a media managing method comprises sorting media according to one or more characteristics of each of the media, forming media channels based on the one or more characteristics associated with the media, and presenting the media in one of the media channels which functions as dynamic or living storage with continuous update media of similar characteristics. In some embodiments, the one or more characteristics comprises contributors who make contents of the media. In other embodiments, the one or more characteristics comprises events shown in the media. In some other embodiments, the one or more characteristics comprises devices captured contents of the media. In some embodiments, the one or more characteristics comprises scenes shown in the media. In other embodiments, the one or more characteristics comprises date, location, or a combination thereof. In some other embodiments, the media from the same channel are presented in a grid as an auto-generated album or program based on sorting criteria. In some embodiments, each of the media in the grid are enlarged when selected. In some other embodiments, the one or more characteristics are generated automatically using photo metadata. In some embodiments, the one or more characteristics are generated automatically using a software to perform graphic analysis. In other embodiments, the graphic analysis comprises object identification. In some other embodiments, the media comprises photos, videos, music, or a combination thereof.

In another aspect, a media managing method comprises creating media, selecting a characteristic for each of the media as a sorting criterium of the media, and forming media channels based on sorting criteria, which is a collection of the sorting criterium.

In some embodiments, the method further comprises sharing one of the channels to non-specified other users. In other embodiments, the method further comprises sharing one of the channels to specified users with a granted access. In some other embodiments, the method further comprises presenting media in one of the media channels.

In another aspect, a media sharing method comprises setting sharing of a set of media channels with others on a portable electronic device, wherein the media channel comprises media of photos, videos, or both indexed by contents or metadata of the media and notifying a server to share the media channel to one or more connected users of an APP. In some embodiments, the method further comprises sharing the set of media channel to a TV streaming device.

In some embodiments, the method further comprises sharing the set of media channel to a uniquely identified TV streaming device. In other embodiments, the uniquely identified TV streaming device comprises a pre-assigned code of a unique identification number. In some other embodiments, the uniquely identified TV streaming device comprises a software generated unique identification number from a remote server.

In another aspect, a media presenting device comprises a characteristic reader configured to read media associated with a predetermined characteristic into a computer memory, a graphic generating unit configured to present the media in an image grid at a selection of a media channel associated with the predetermined characteristic and a storage device configured to store the media locally in the device for temporary caching or permanent storage.

In some embodiments, the media presenting device comprises a remote control configured to control media browsing, scrolling, playing, editing and controlling. In some embodiments, the media presenting device comprises a TV streaming box. In other embodiments, the media presenting device comprises a media sorting component automatically sorting the media into respective channels based on one or more identified characteristics. In some other embodiments, the identified characteristics comprise metadata of the media. In some embodiments, the identified characteristics comprise analyzed content of the media.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a typical TV program guide.

FIG. 2 illustrates a typical media album structure.

FIG. 3 illustrates a media transmitting structure in accordance with some embodiments.

FIGS. 4A and 4B illustrate a manual or automatic media arrangement system in accordance with some embodiments.

FIGS. 5A and 5B illustrate a dynamic media arrangement system in the program/channel in accordance with some embodiments.

FIG. 6 contains flow charts of media channel operating methods in accordance with some embodiments.

FIGS. 7A, 7B, 8A, 8B, 9A, 9B, 10A, 10B, 10C, and 10D are illustrative screen shots of media/photos by channels in accordance with some embodiments.

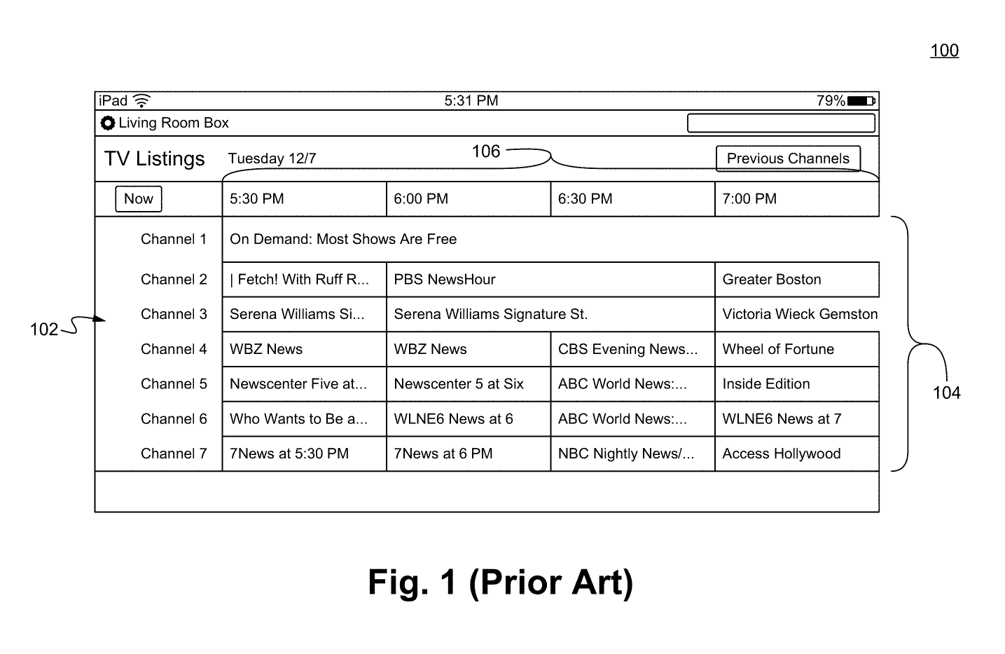

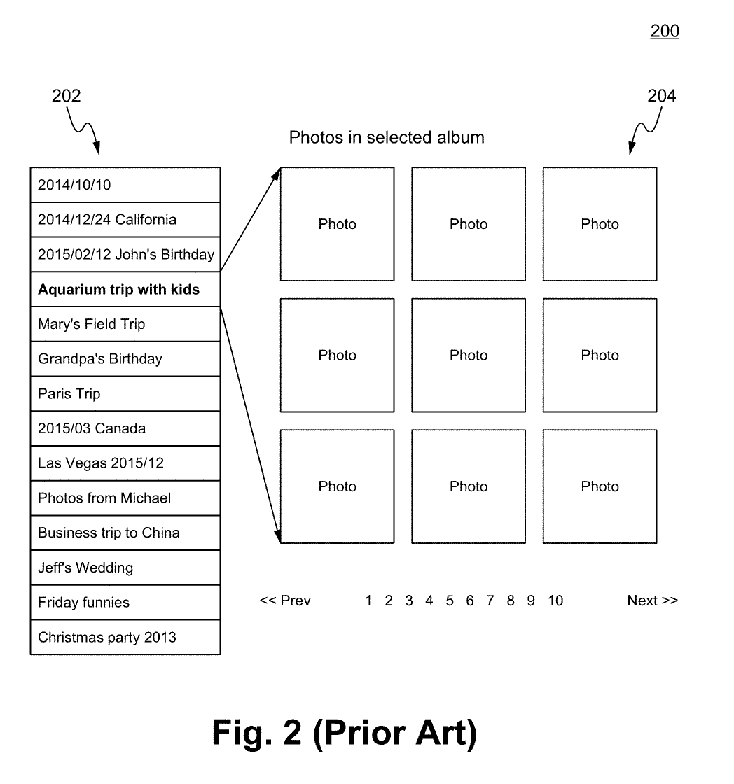

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

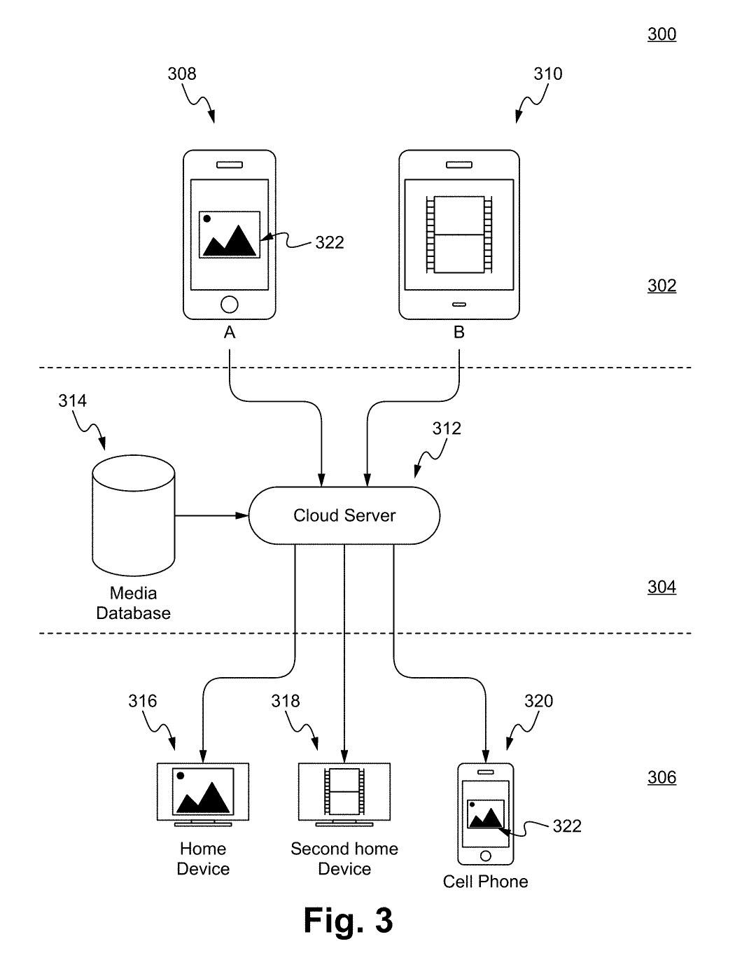

FIG. 3 illustrates a media transmitting structure 300 in accordance with some embodiments. In some embodiments, the media transmitting structure 300 comprises three or more levels, including a media acquiring level 302, a remote media storing level 304, and a media downloading level 306.

In some embodiments, the media acquiring level 302 comprises a smart phone 308, a tablet 310, or any other media acquiring devices. A person of ordinary skill in the art would appreciate that any other media acquiring devices are within the scope of the present invention. For example, devices that acquire photos, videos and sounds. The devices at the media acquiring level 302 can comprise a data storing components on the devices.

In some embodiments, the remote media storing level 304 comprises a cloud server 312, a media database 314 in a server, or both. Any media storing devices or data transmitting methods and devices are within the scope of the present invention.

In some embodiments, the media download level 306 comprises one or more devices that are able to display the media and/or store data in their storing devices. The devices at the media download level 306 can be a TV 316, a second home electronic device 318 (e.g., a second home TV) and a smart phone 320. Any other electronic devices are able to be the devices at the media download level 306, so long as the electronic devices are able to edit and/or show the media. The devices at the media download level 306 are able to upload and/or download media or control commands to the devices in the media acquiring level 302, remote media storing level 304, or both.

In an example, media 322 (e.g., personal photos and/or videos) can be created or captured by one of the mobile devices 308. The media 322 is able to be uploaded to the cloud server 312 for storage and/or indexing. The media 322 is able to be distributed to TV 316, the mobile device 320, and/or PC for sharing and preserving/storing. The media 322 is able to be uploaded from PC or various Internet connected devices.

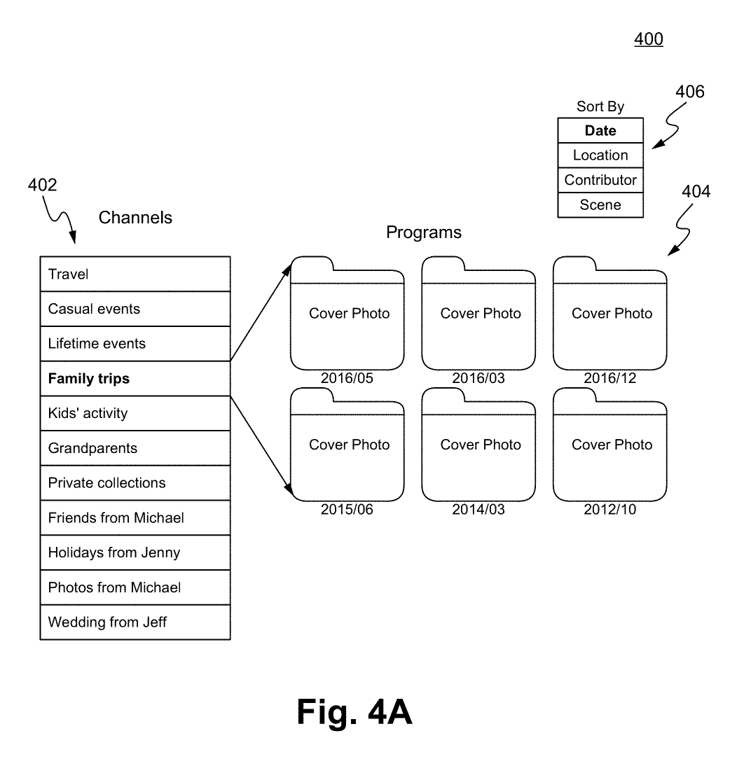

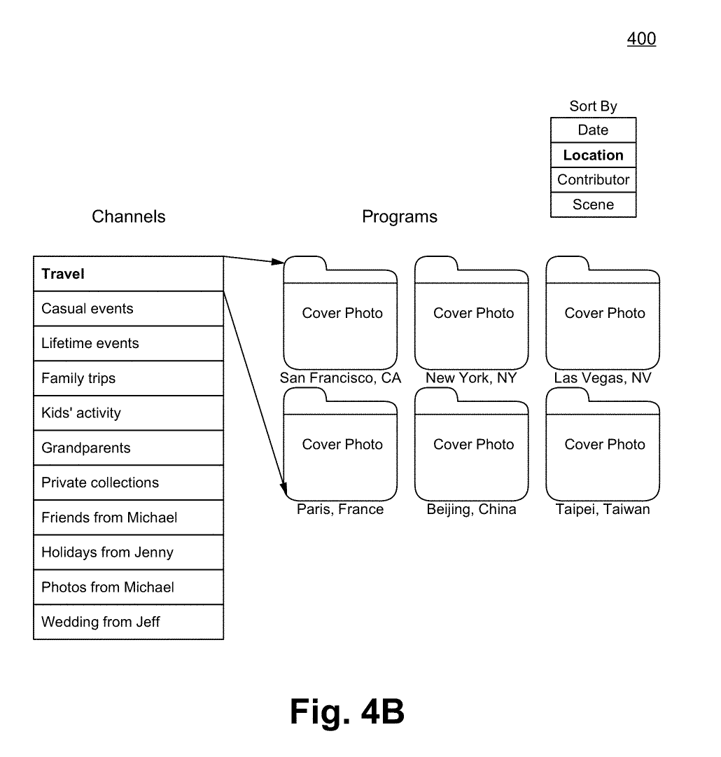

FIGS. 4A and 4B illustrate a manual or automatic media arrangement system 400 in accordance with some embodiments. The system 400 is able to create/sort media programs manually or automatically. The programs are able to be media (e.g., photos) of the same category and/or characteristic. In some embodiments, the media is structured to be stored in channels 402. The channels are able to be sorted by categories, collections, and live streams. In some embodiments, the channels are categorized and created by user-specific topics, including “Travel,” “Family,” and “Events.” In some embodiments, the media that are categorized into one or more specific channels when one or more characteristics are detected or found. For example, in a “Kids” channel, photos containing young kids and/or toys are characterized as photos in the “Kids” channel.

In some embodiments, the characteristics are identified automatically, such as using a face identification software, an object identification software, a graphic analysis software, and/or the metadata. The metadata can include technical metadata, descriptive metadata, and administrative metadata. In some embodiments, the descriptive metadata comprises captions, headlines, titles, keywords, and location of capture. In some embodiments, the types of the metadata includes IPTC-IIM, IPTC Core & Extension, PLUS, XMP, Exif, and Dublin Core. Using the metadata, the media is ale to be attributed to or characterized with one or more specific characteristics. For example, when the location of a photo stored in the metadata is not the place of usual visiting or with personal effects, such as home, office, or frequent visited restaurants, the photo is able to be tagged or characterized as a traveling photo or a candidate for a traveling photo.

In some embodiments, the identification of the characteristics is performed manually. A user is able to enter the characteristics of the photo by typing or verbally. In some embodiments, a user is able to enter the characteristics for the first few photos, and machine learning is used to automatically identify the persons, objects, or locations in the photo through the similarity of the objects (e.g., >65% of image similarity) or recognizable patterns.

In some embodiments, the location of the photo taken is beyond a predefined distance from work or home, the photo is tagged or characterized as a travel photo or a candidate of the travel photo. In some embodiments, the GPS location of where the photo was taken is determined as one of popular sites for visitors or the image is determined as a famous object (e.g., the Golden Gate bridge), the photo is tagged or characterized as a travel photo or a candidate for a travel photo.

In some embodiments, the media for the “family” channel is able to be determined by a user's definition via a relationship input. In some embodiments, the family relationship is learned by the device or the cloud server (312 of FIG. 3) via other connections, such as the photo labeling functions on Facebook. Any methods and mechanisms that are able to be used to identify the relationships between the device user/owner and the person in the media are within the scope of the present invention.

In some embodiments, the media for the “events” channel is able to be determined by location, time, person or content of the image, or a combination thereof of the photo/media is taken. For example, the GPS location recorded as Liberty Island of New York is able to be determined as a vacation or sightseeing event for the event channel. In another example, when the recording time of a photo is taken during the day that the user's calendar is marked as son's birthday or when the photo is analyzed with a birthday cake, the photos are tagged or attributed as birthday photos.

In some embodiments, the channels function as dynamic or living storage. Users are able to continuously update photos that have similar characteristics for the specific channel. In some embodiments, the photos or media are automatically assigned one or more characteristics based on the above detectable characteristics (e.g., the GPS location), so that the photos and media are automatically grouped/stored with the photos and media with same or similar characteristics. In some embodiments, a user is able to browse the photos and media as the channels in a TV program guide. In some embodiments, the system is configured to automatically organize into “programs” or “albums” based on the sorting methods, including dates, locations, contributors, and scenes. In some embodiments, the users manually create “programs,” which are used as channels. In some embodiments, each of the programs is a collection of photos that contains information matches one or more of the sorting criteria (e.g., the characteristics). In some embodiments, each of the programs is dynamically generated, such that the users do not need to manually update the programs.

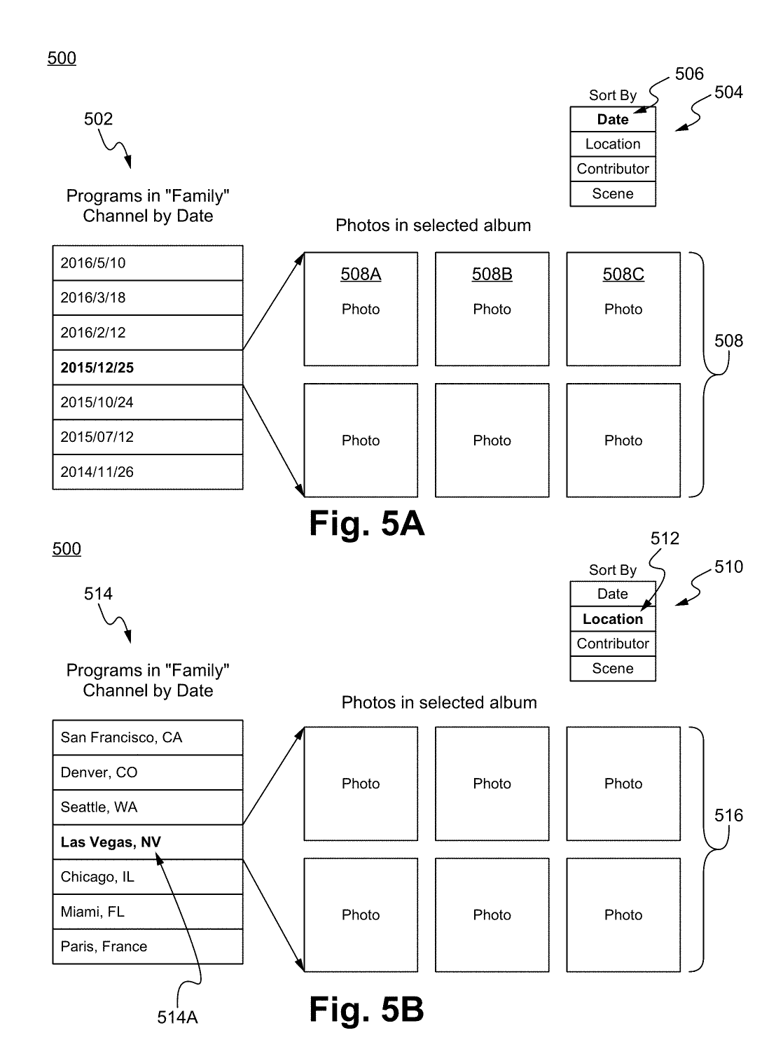

FIGS. 5A and 5B illustrate a dynamic media arrangement system 500 in accordance with some embodiments. The system 500 is able to create/sort media programs dynamically, wherein the media are sorted based on various dynamic factors, such as surrounding listed/displayed media, user's input, and search key words. FIG. 5A illustrates that the media arrangement structure 500 (e.g., program or channel) is created based on the date. In some embodiments, a user selects the “date” 506 as the sorting method in the sorting method box 504. Available media/photos at different dates are listed in the scrollable box 502. When a specific date is selected in the scrollable box 502, the photos or media (e.g., video or sound recording) are presented in a matrix 508, which is similar to a TV show program selectable by the user. In some embodiments, the matrix 508 is scrollable up and down, so that more photos are able to be loaded like a wheel in a continuous and non-stop manner. In some embodiments, the matrix 508 is loaded with one new row at a time to replace a row that was presented. In some embodiments, the matrix 508 is loaded with one new page at a time to replace an entire page of photos or media that were presented. In some embodiments, the matrix 508 is loaded with one new photo or media at a time to replace a single photo or media that was presented. The new photos or media to be presented are able to be selected based on various criteria, such as the degree of relevance of the surrounding photos or media. For example, when the photo 508B is selected to be replaced, the system 500 is able to replace the photo 508B based on the related content of the images of 508A and 508C. In an example, when the photo 508A shows a California scene and the photo 508C shows a Oregon scene, the photo 508B is able to be selected with a location close to California and Oregon, such as a scene of Nevada.

Using the system 500, the numbers of photos and media that are needed to be loaded into the computing memory are reduced, since pre-qualified photos and media (e.g., matching the sorting/attributing criteria) are reduced. Such advanced features enhances the computing efficiency and computing speed by narrowing down to less qualified items to be read and/or loaded.

FIG. 5B illustrates that the media arrangement structure 500 (e.g., program or channel) is created based on the location. In some embodiments, the location information is obtained through the geo-location info from a built-in GPS of the image/media acquiring device (e.g., a smart phone). In some embodiments, a user uses a remote (e.g., an infrared remote control; a TV remote control) to scroll up and down the sorting menu 510 and selects a “Location” based sorting selection 512. The selection 512 makes the channels 514 display locations of the photos and media that are acquired. For example, if the user selects “Las Vegas, Nev.” 514A, the photos that are taken at Las Vegas are displayed at the album area 516.

In some embodiments, the sorting methods of the system 500 use various sorting factors (e.g., priority), processes, criteria, and/or characteristics. For example, the sorting of the photos and media is able to be done based on “contributors,” “devices,” “scenes,” and any other sorting criteria. In some embodiments, the system 500 sorts the photos and media based on “contributors,” which is a sorting method based on the owner of the photos. For example, the system sorts the photos according to the alphabetic order of the last name of the photo owners.

In some embodiments, the sorting method of the system 500 sorts the photos and media using “devices” as the sorting criteria. The photos in the system 500 are able to be a collection of photos and media from various devices (e.g., smart phone, notebook computer, and tablet). The system 500 is able to sort the photos and media based on the source of the devices.

In some embodiments, the sorting method of the system 500 is able to automatically detect the scenes in the photo/media and arrange the photos and media based on the scenes detected. For example, the scenes detected can be beach, sky, building, people, animal, and sunset. In some embodiments, each of the photos or media is only attributed to one of the characteristics, so each of the photos or media will only appear in one channel or attribute to one characteristic. In the above case, only the most highest priority or highest relevance tag or characteristic is used as the sorting criteria. In some embodiments, multiple characteristics are used as factors in deciding/factoring which channel or channels that the photo or media should be attributed to.

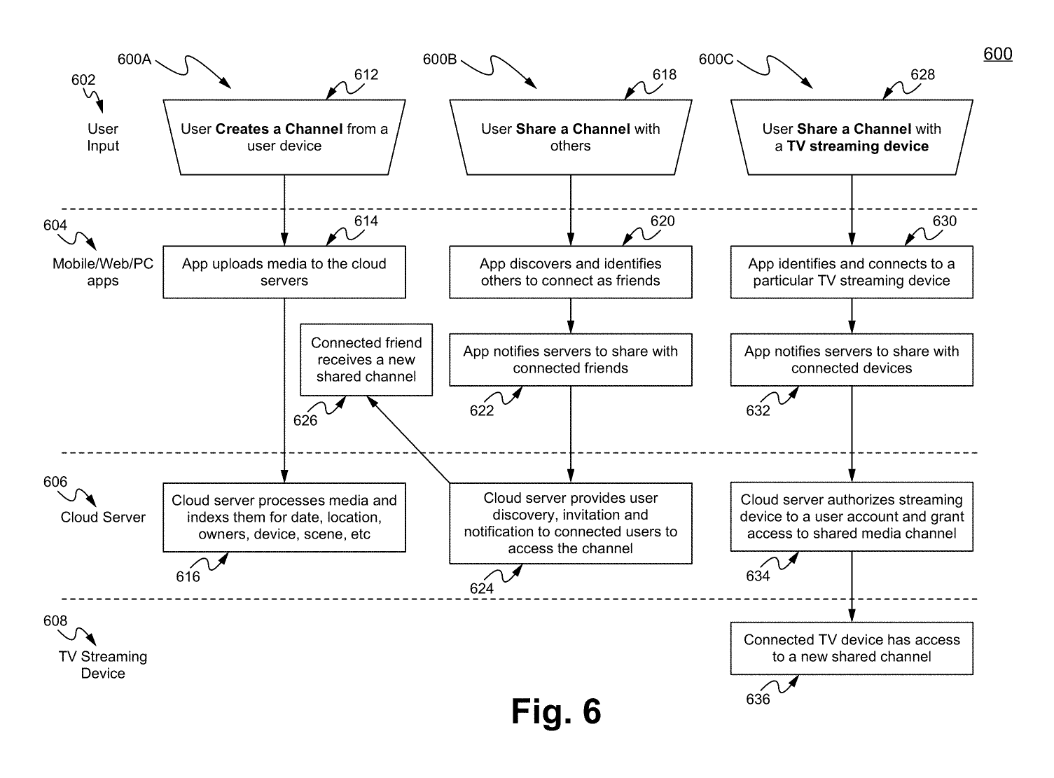

FIG. 6 illustrates flow charts of media channel operating methods 600 in accordance with some embodiments. In some embodiments, the methods 600 include a user input level 602, mobile/Web/PC apps level 604, a cloud sever level 606, and a TV streaming device level 608. The method 600 is able to include a channel creating process 600A and channel sharing processes 600B and 600C.

In some embodiments, the process 600A includes creating channels with different characteristics on a user's device at a Step 612, using an APP (e.g., smart phone Apps; Apps in Apple's App store) to upload media/photos to a storage of one or more cloud servers at a Step 614, and processing media/photos and indexing/attributing the media/photos based on the date, location, owners, devices, and scenes using the cloud server at a Step 616, such that the media/photos are categorized into the channels based on their respective characteristics.

In some embodiments, the process 600B includes sharing/publishing a channel using an APP in an APP store by a user at a Step 618, using the APP to discover and identify others' channels/APPs to be connected as friends at a Step 620, using the APP to notify the servers to share the user shared/published channel with the connected friends at a Step 622, using the cloud server to provide user discovery and invitation and to notify connected users to access the user shared/published channel at a Step 624, and having the connected friends to receive the user published/shared channel at a Step 626.

In some embodiments, the process 600C includes sharing a channel by a user with a TV streaming device at a Step 628, using an APP to identify and connect with the TV streaming device at a Step 630, using the APP to notify a server to share the channel (e.g., the photos and media) with the connected TV streaming device at a Step 632, using a cloud server to authorize and grant access by the TV streaming device to a user account and the shared media channel/content associated with the user account at a Step 634, connecting a TV/display with the TV streaming device at a Step 636, such that the user has access to the shared media channel/content. In the process 600C, a user is able to share a channel (e.g., media content) to a TV streaming device by a unique identifying number of the TV streaming device. Next, the user is able to grant access to the user's account and the contents associated with the account on the TV streaming device.

In some embodiments, the TV streaming device is a local network. In other embodiments, the TV streaming device is a remote device accessible via the Internet. In some embodiments, the TV or TV streaming device identification can be generated by using a hardware unique device ID (HUDID), which can be assigned at the time when the hardware is manufactured. In some other embodiments, the TV or TV streaming device identification is able to be generated by using a software-generated code from a cloud server. In such case, a TV device requests a server to generate a series of identification codes to be displayed on TV, which is able to be used as a sharing code for this TV device. The sharing code is able to be entered into an APP to share the content of this TV device. In some embodiments, the sharing code is time sensitive, which expires in a predetermined time (e.g., 30 minutes) for security purposes. In some embodiments, the sharing code is in a form of a QR code, which enables a scanning method to enter the code.

In some embodiments, the TV streaming device is configured to receive channels from multiple users with multiple devices. In some embodiments, a user is able to share a channel to multiple TV streaming devices, which can be located in different physical locations.

In some embodiments, the TV streaming device is configured to download media (e.g.: photos, videos or music) from media capturing devices (e.g.: cameras, PC or other storage devices) to certain channels to enjoy media within a local home network.

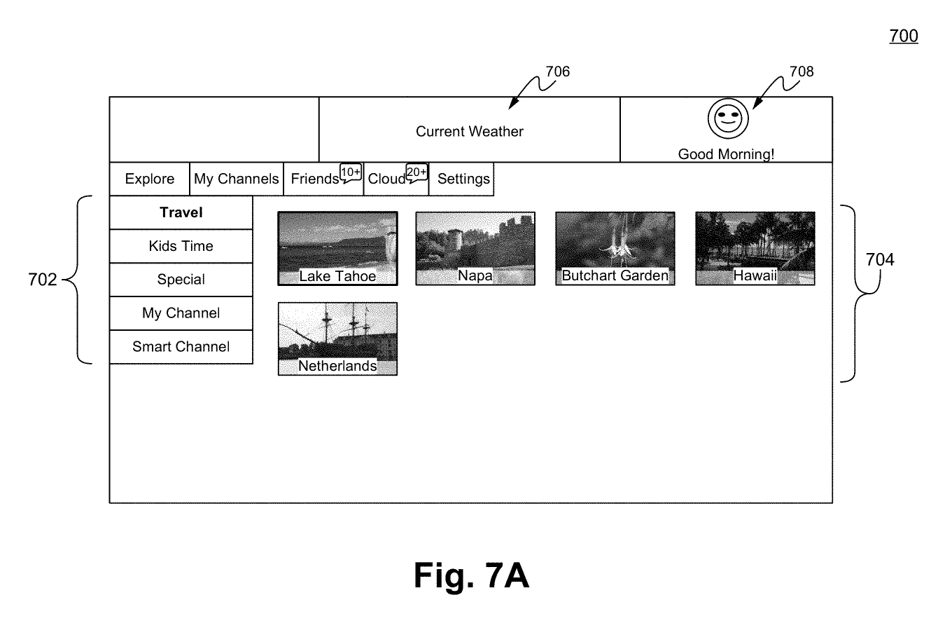

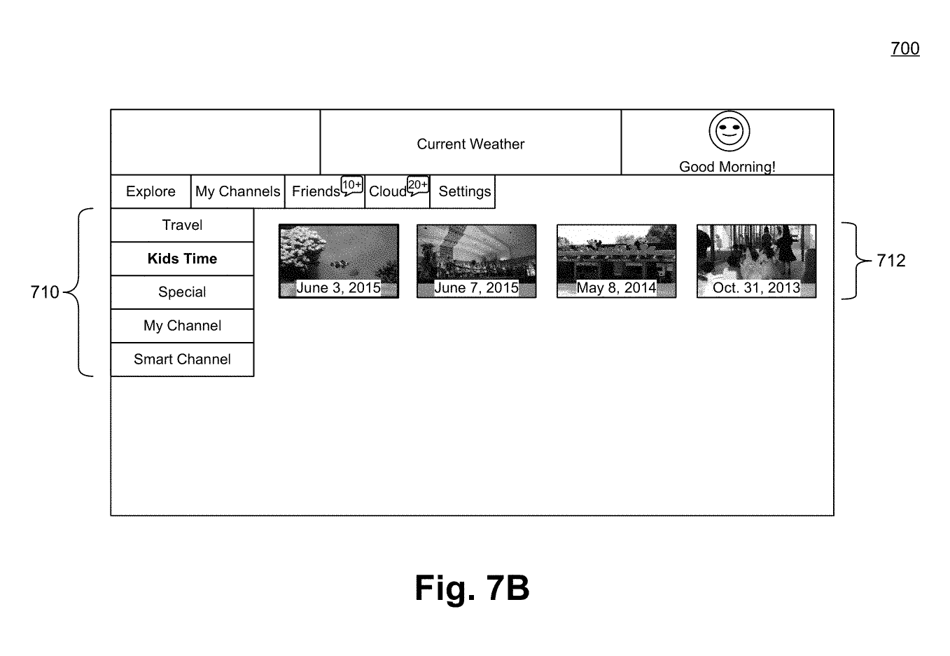

FIGS. 7A, 7B, 8A, 8B, 9A, 9B, 10A, and 10B are illustrative screen shots of media/photos by channels in accordance with some embodiments. FIG. 7A illustrate a media presenting system 700 based on type of media 702, including travel, kids time, special, my channel, and smart channel. The media associated with the selection (e.g., travel) are presented in a grid matrix at the media displaying area 704. The system 700 is able to include a dynamic information area 706 and account info 708.

FIG. 7B illustrates a media presentation of kids time, which is presented based on the time stamp 712 in the channel of “kids time” 710. The media in the channel are arranged based on the sorting selection, such as time, location, events, and contributors.

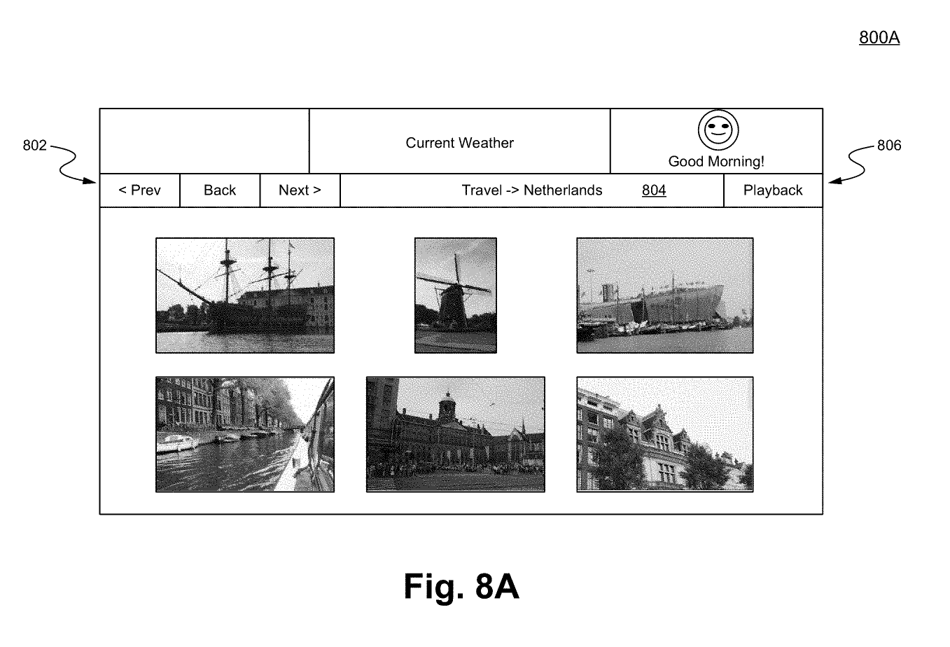

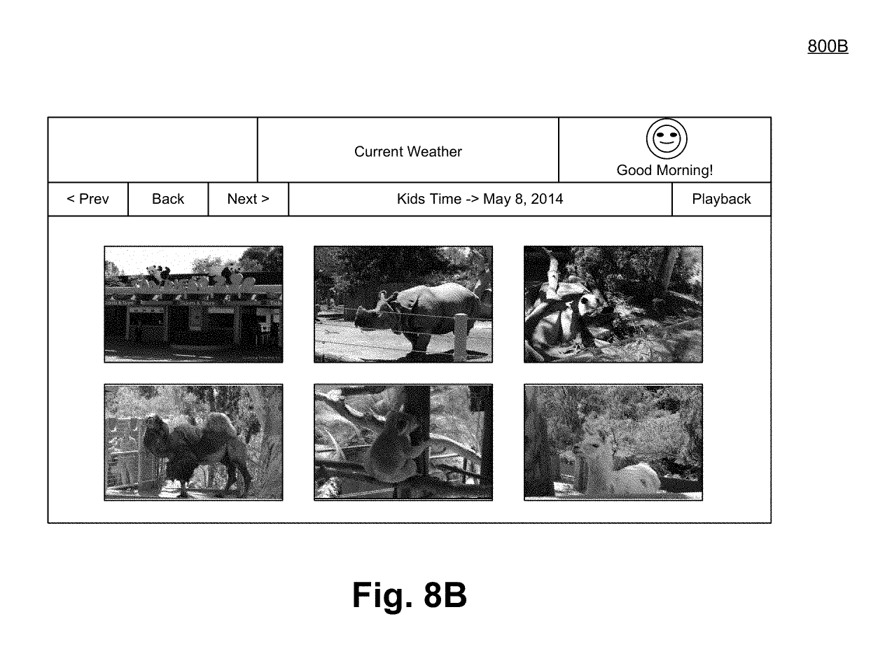

FIG. 8A illustrates a media presentation sorting system 800A, which is based on a sorting criteria of location. The system 800A includes a play control 802, channel information 804, and playback button 806. A user is able to scroll photos or media up-and-down and left-and-right using a controlling device, such as a TV remote control. FIG. 8B illustrates a media presentation sorting system 800B, which is based on a sorting criteria of photos relate to kids' activities. In some embodiments, each of the photos or media are able to be individually selected to be displayed in a full screen, slide show, or video playback.

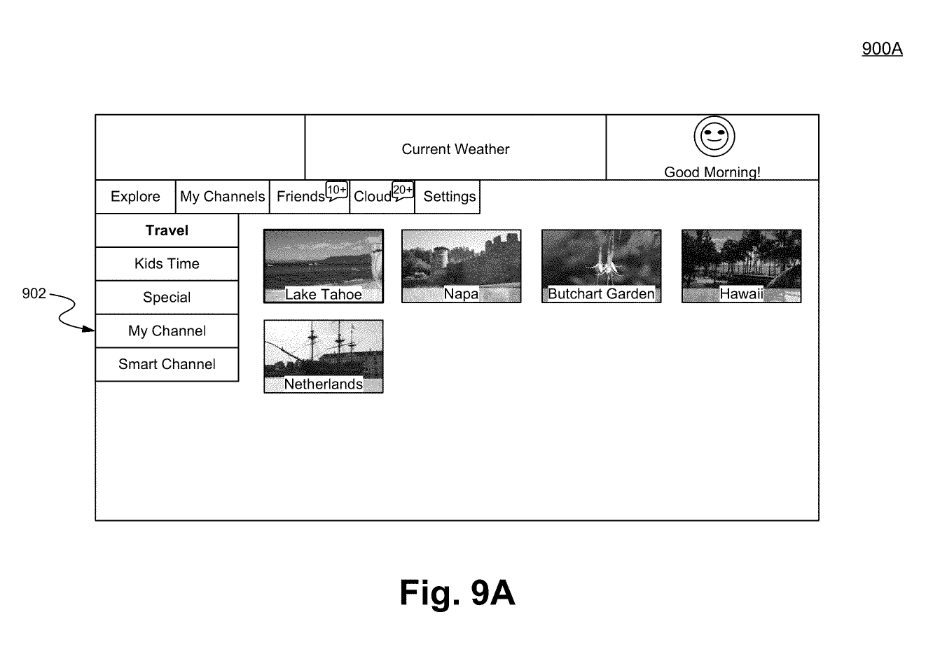

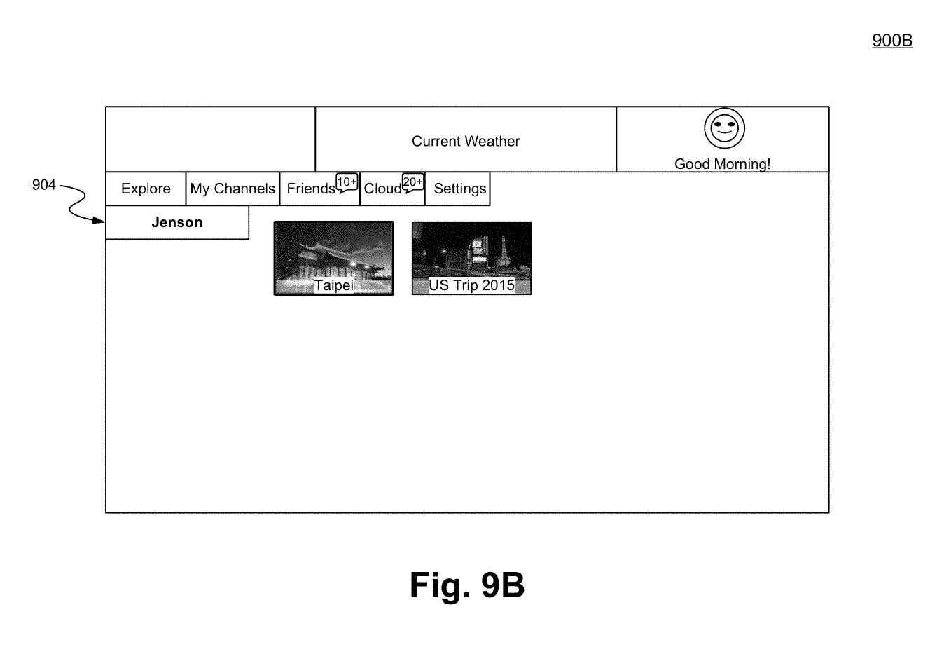

FIG. 9A illustrates a media presentation sorting system 900A, which is based on a user created channel 902. FIG. 9B illustrates a media presentation sorting system 900B, which is based on a shared channel 904, which is able to be from a connected friend or from any other users.

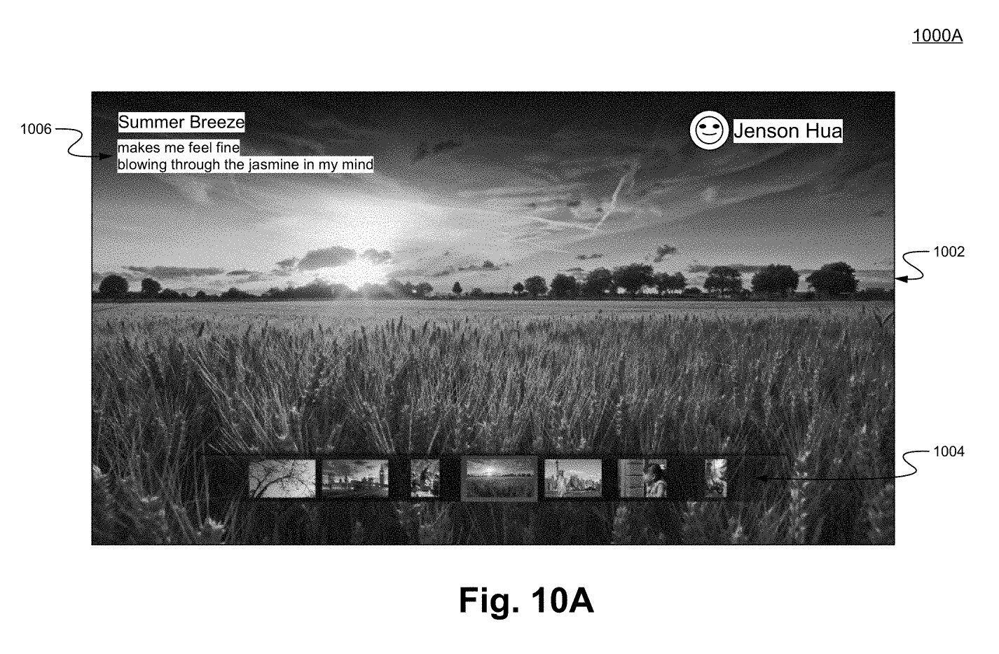

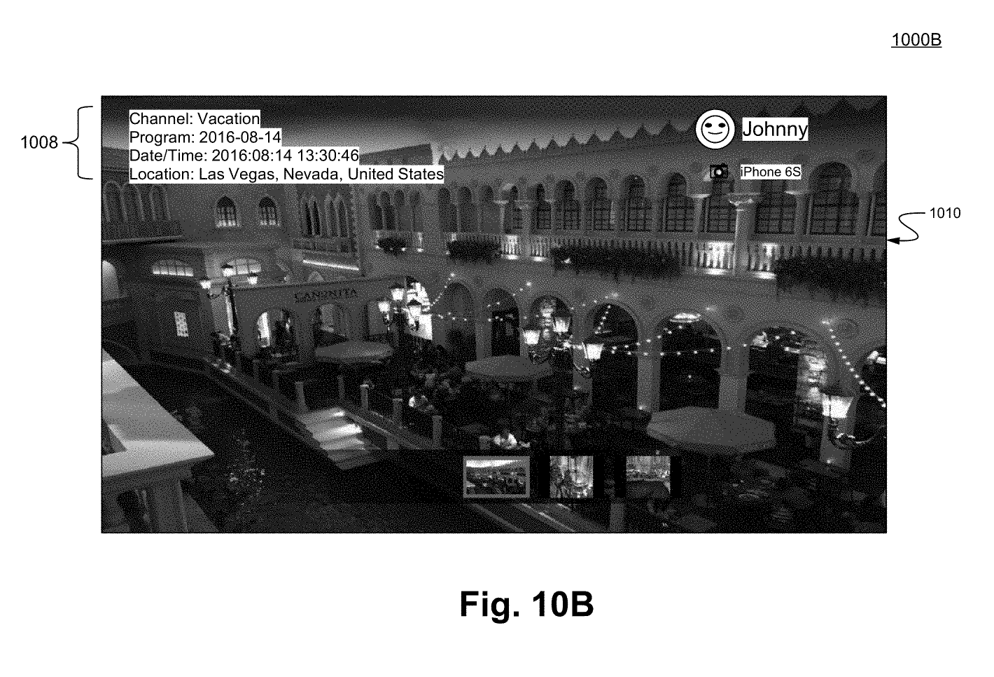

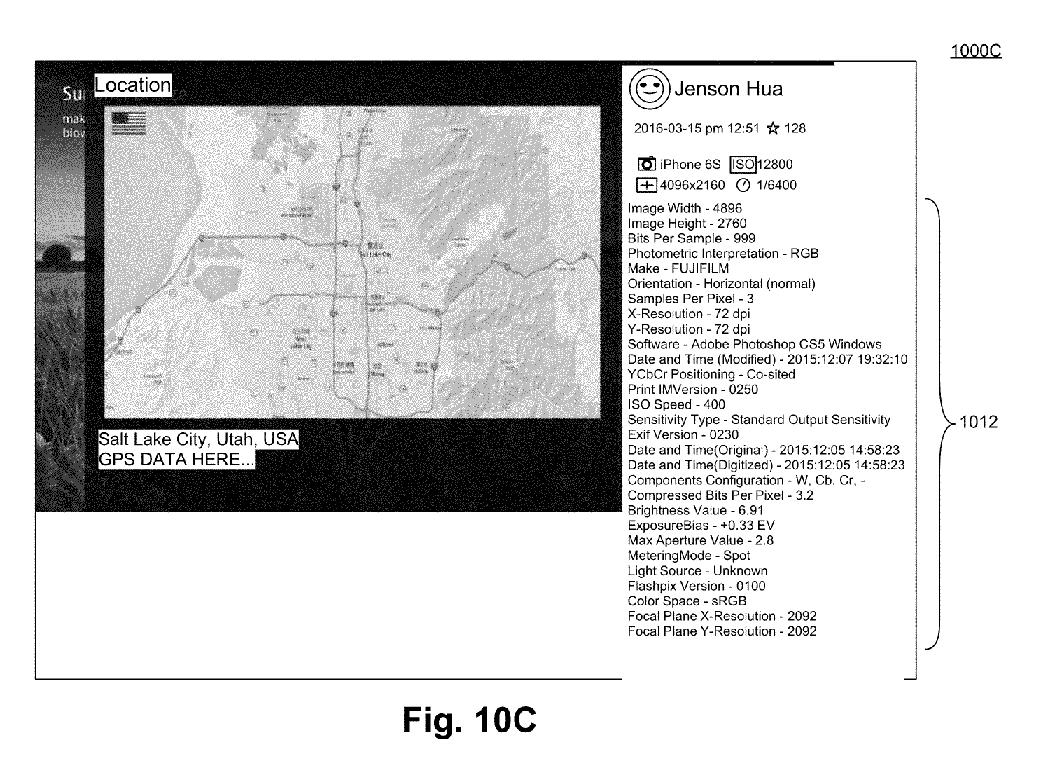

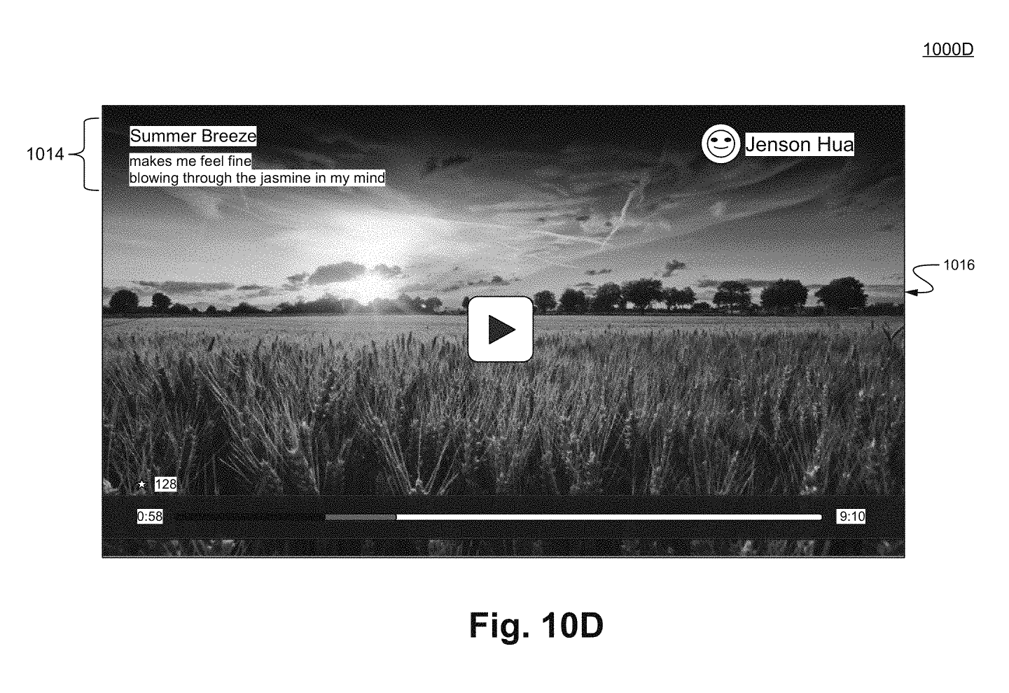

FIG. 10A illustrates a media presentation system 1000A, which is in a full screen mode. The media is displayed in a full screen mode 1002 with information 1006 (e.g., title, user descriptions, and/or owner info) on left top of the screen. The preview panel 1004 provides a preview of the up coming next photo in the queue and previous showed media.

FIG. 10B illustrates a media presentation sorting system 1000B, which is in a full screen mode. The media is displayed in a full screen mode 1010 with information 1008 (e.g., channel, program, date, location, user or device info) on left top of the screen.

FIG. 10C illustrates a media presentation sorting system 1000C, which is in a full screen mode with detailed photo information 1012. The detailed information 1012 can be displayed in an overlay detailed view, which can include locations, device, and the information recorded about the photo when it is captured.

FIG. 10D illustrates a media presentation sorting system 1000D, which is in video playback format. The detailed information 1014 can overlay on top of the video 1016.

To utilize, the media (e.g., photos and videos) are presented in channels similar to TV show programs.

In operation, the media is acquired, one or more characteristics are associated or attributed to the media, and the media is sorted based on its characteristics. The sorting of the media can be performed before a user is making a selection, such that the media has been pre-sorted and/or reallocated in the storage location, which can enhance the loading and computing efficiency by shortening the sorting time and calculation time when a selection command is made.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

What is claimed is:

1. A media managing method comprising:
a) sorting media according to one or more characteristics of each of the media;
b) forming media channels based on the one or more characteristics associated with the media; and
c) presenting the media in one of the media channels which functions as dynamic or living storage with continuous update media of similar characteristics.

2. The media managing method of claim 1, wherein the one or more characteristics comprises contributors who make contents of the media.

3. The media managing method of claim 1, wherein the one or more characteristics comprises events shown in the media.

4. The media managing method of claim 1, wherein the one or more characteristics comprises devices that captured contents of the media.

5. The media managing method of claim 1, wherein the one or more characteristics comprises scenes shown in the media.

6. The media managing method of claim 1, wherein the one or more characteristics comprises date, location, or a combination thereof.

7. The media managing method of claim 1, wherein the media from the same channel are presented in a grid as an auto-generated album or program based on sorting criteria.

8. The media managing method of claim 7, wherein each of the media in the grid are enlarged when selected.

9. The media managing method of claim 1, wherein the one or more characteristics are generated automatically using photo metadata.

10. The media managing method of claim 1, wherein the one or more characteristics are generated automatically using a software to perform graphic analysis.

11. The media managing method of claim 10, wherein the graphic analysis comprises object identification.

12. The media managing method of claim 1, wherein the media comprises photos, videos, music, or a combination thereof.

13. A media managing method comprising:
a) creating media;
b) selecting a characteristic for each of the media as a sorting criterium of the media; and
c) forming media channels based on sorting criteria, which is a collection of the sorting criterium.

14. The media managing method of claim 13, further comprising sharing one of the channels to non-specified other users.

15. The media managing method of claim 13, further comprising sharing one of the channels to specified users with a granted access.

16. The media managing method of claim 13, further comprising presenting media in one of the media channels.

17. A media sharing method comprising:
a) setting sharing of a set of media channels with others on a portable electronic device, wherein the media channel comprises media of photos, videos, or both indexed by contents or metadata of the media; and
b) notifying a server to share the media channel to one or more connected users of an APP.

18. The media sharing method of claim 17, further comprising sharing the set of media channel to a TV streaming device.

19. The media sharing method of claim 17, further comprising sharing the set of media channel to a uniquely identified TV streaming device.

20. The media sharing method of claim 19, wherein the uniquely identified TV streaming device comprises a pre-assigned code of a unique identification number.

21. The media sharing method of claim 19, wherein the uniquely identified TV streaming device comprises a software generated unique identification number from a remote server.

22. A media presenting device comprising:
a) a characteristic reader configured to read media associated with a predetermined characteristic into a computer memory;
b) a graphic generating unit configured to present the media in an image grid at a selection of a media channel associated with the predetermined characteristic; and
c) a storage device configured to store the media locally in the device for temporary caching or permanent storage.

23. The device of claim 22, further comprising a remote control configured to control media browsing, scrolling, playing, editing and controlling.

24. The device of claim 22, wherein the media presenting device comprises a TV streaming box.

25. The device of claim 22, wherein the media presenting device comprises a media sorting component automatically sorting the media into respective channels based on one or more identified characteristics.

26. The device of claim 22, wherein the identified characteristics comprise metadata of the media.

27. The device of claim 22, wherein the identified characteristics comprise analyzed content of the media.
